(19) United States
(12) Patent Application Publication
(10) Pub. No.: US 2008/0017588 A1
(43) Pub. Date: Jan. 24, 2008

(54) Method and Apparatus For Producing Sterile Water Containing Hypochlorus or Chlorous Acid As a Major Component

(75) Inventors: Tatsuo Okazaki, Fujimino-shi (JP); Yoshinori Ota, Ageo-shi (JP); Hiroshi Teranishi, Nagareyama-shi (JP)

Correspondence Address: KILYK & BOWERSOX, P.L.L.C., 400 HOLIDAY COURT, SUITE 102, WARRENTON, VA, 20186, US

(73) Assignees: VEETA INC., Saitama (JP); APRO CO., LTD., Tokyo (JP)

(21) Appl. No.: 11/843,445

(22) Filed: Aug. 22, 2007

Related U.S. Application Data
(63) Continuation of application No. PCT/JP2006/303528, filed on Feb. 21, 2006.

(30) Foreign Application Priority Data
Feb. 23, 2005 (JP) JP2005-084747
Feb. 23, 2005 (JP) JP2005-084767

(51) Int. Cl. C02F 1/76

(52) U.S. Cl. 210/754; 210/756; 210/206; 422/37

(57) ABSTRACT

Carbon dioxide is supplied from a carbon dioxide cylinder (15) to a pressure vessel (13) through reducing valves (18 and 19). The pressure vessel (13) is also supplied with a sodium hypochlorite water solution having a desired concentration through a material supply pipe (12). The material supply pipe (12) is connected to first and second branch pipes (100 and 101) through a distribution valve (102). The sodium hypochlorite water solution supplied through the material supply pipe (12) is partially sprinkled to a gas-phase region in the pressure vessel (13) through the first branch pipe 100, while the remainder of the sodium hypochlorite water solution is supplied to a liquid-phase region in the pressure vessel (13) through the second branch pipe (101). The pressure vessel (13) is provided with a liquid level retention mechanism (25 to 29) is provided to retain the liquid level in the pressure vessel (13) within a constant range. Sterile water produced in the pressure vessel (13) is delivered through a discharge pipe (31) incorporating a throttle valve (42). The pH value of the sterile water is detected by a pH sensor, and the distribution valve (102) is controlled until the detected pH value coincides with an intended pH value.

### BACKGROUND OF THE INVENTION

1. Field of the Invention

The present invention relates to a method and apparatus for producing sterile water containing hypochlorous or chlorous acid as a major component.

2. Background Art

It is well known that the sterile water containing hypochlorous or chlorous acid as its major component is harmless to the human body and highly effective in sterilization. For example, when the free chloric acid concentration is adjusted to about 200 ppm by diluting sodium hypochlorite with water, the sodium hypochlorite water solution will have a pH value of about 8.6, and the sodium hypochlorite will contain the hypochlorous acid in about 10%. As well known, the content of hypochlorous acid in the solution depends upon the pH value and will be about 100% in a weak acid range of about 5 in pH value.

There have been proposed the following methods of producing sterile water containing hypochlorous or chlorous acid as a major component. A first typical one of the methods is to produce sterile water by mixing a sodium hypochlorite (chlorite) water solution and an acid such as hydrochloric acid (diluted) (cf. Japanese Published Unexamined Patent Applications JP 2004-35037, JP 2005-161142 and JP 2005-349382). A second one of the methods is to produce sterile water containing hypochlorous acid by direct electrolysis of hydrochloric acid as its major component. A third one of the methods is to make electrolysis with sodium chloride put in an electrolytic bath having a membrane disposed between an anode and cathode to produce a hypochlorous acid water solution around the anode (cf. Japanese Published Unexamined Patent Application JP H03-258392). A fourth one of the methods is to prepare a hypochlorous acid water solution by electrolysis of a mixed water solution of hydrochloric acid and sodium chloride (cf. Japanese Published Unexamined Patent Application JP H06-99174).

The above first method in which the sodium hypochlorite (chlorite) water solution and acid are mixed is advantageous in that sterile water can easily be produced which contains the hypochlorous or chlorous acid as the major component. However, it has a problem that the quantity of the acid to be added cannot easily be controlled For example, if the acid is added in a quantity slightly larger than necessary, the pH value will suddenly fall below pH 3 into a range of gasification in which gaseous chlorine and gaseous chlorine dioxide will be produced. This problem is typically symbolized by a caution label reading “Never use with acid” attached on a commercially available container of a pesticide or bleach containing sodium hypochlorite, for example.

Concerning the above second and third methods adopting the electrolysis, when electrolytic conditions are to be set around pH 5 at which the percentage of hypochlorous acid content is high, the electrolytic bath needs delicate control. Actually, therefore, the electrolytic condition is necessarily enlarged to near pH 7 to control the electrolytic bath.

In the above fourth method adopting the electrolysis, sodium chloride is put in an electrolytic bath having no membrane between the anode and cathode to produce sodium hypochlorite of a high concentration, and then the product is diluted with dilution water to produce sterile water containing hypochlorous acid as its major component as disclosed in the Japanese Published Unexamined Patent Application JP H06-99174. In this fourth method, dilute hydrochloric acid is added so that the pH value will be automatically adjusted when the sodium hypochlorite is produced by the electrolysis. For production of sterile water of a desired pH value, however, it is necessary to strictly adjust the concentration of the dilute hydrochloric acid. On the other hand, for producing the sterile water having a desired concentration, it is necessary to adjust the quantity of the dilute hydrochloric acid. However, an apparatus used to effect this fourth method should be controlled in an impracticable manner to attain both the desired concentration and pH value. Therefore, it is not avoidable to set a wide target range of pH value.

An apparatus for effecting the above methods to produce the sterile water containing the hypochlorous or chlorous acid as the major component has a sterile water outlet pipe connected thereto (as in the Japanese Published Unexamined Patent Application JP 2004-181445). The outlet pipe has an end-stop valve or a faucet. When the valve or faucet is opened, the sterile water is delivered for use. The sterile water is delivered in different amounts; for example, an extremely small amount of the sterile water is continuously delivered for use with the faucet being opened slightly or a large amount is delivered with the faucet being full opened, whichever is appropriate. Namely, in the sterile water producing apparatus, the sterile water throughput cannot be maintained constant, which makes it to be difficult to maintain a constant pH value and concentration. Thus, it has been considered that the sterile water producing apparatus should be equipped with an accumulator and a tank for storage of the produced sterile water as accessory facilities.

### SUMMARY OF THE INVENTION

Accordingly, it is preferable to overcome the above-mentioned drawbacks of the related art by providing a method and apparatus for producing sterile water containing hypochlorous or chlorous acid as its major component and having a stable pH value.

Also it is preferable to provide a method and apparatus for producing sterile water containing hypochlorous or chlorous acid as its major component and which are capable of preventing the pH value from falling to a range of gasification in which it is pH 3 or lower.

Also it is preferable to provide a method and apparatus for producing sterile water containing hypochlorous or chlorous acid as its major component and having a high concentration and which are capable of maintaining a constant pH value without having to make any special control.

Also it is preferable to provide a sterile water producing method and apparatus capable of producing sterile water containing hypochlorous or chlorous acid as its major component while suppressing the variation in pH value of the sterile water without being influenced by any manner in which the sterile water is used.

The present invention is basically characterized in that a sodium hypochlorite or chlorite water solution is adjusted in pH value with carbon dioxide to produce sterile water containing hypochlorous or chlorous acid as a major component

The modes of carrying out the present invention include a first one in which the carbon dioxide and sodium hypochlorite or chlorite water solution are brought into direct contact with each other, and a second one in which the carbon dioxide is brought into contact with water to produce carbonated water and the carbonated water is added to the sodium hypochlorite or chlorite water solution. That is, bringing the carbon dioxide into contact with water, sodium hypochlorite or chlorite water solution to dissolve the former into the latter will contribute to the adjustment in pH value of the sodium hypochlorite or chlorite water solution. A preferred embodiment of the present invention, in which sodium hypochlorite water solution is used, will be explained below as a typical example. The explanation, however, is also applicable to any embodiments of the present invention in which sodium chlorite water solution is used.

For bringing carbon dioxide and sodium hypochlorite water solution into contact with each other, the sodium hypochlorite water solution may be formed into bubbles by supplying, by sprinkling, to a gas-phase region, or directly to a liquid-phase region, in a carbon dioxide-filled vessel, for example. The sodium hypochlorite water solution may be supplied to the gas-phase region either by sprinkling like shower or by spraying or jetting by a nozzle. Solubility of the carbon dioxide depends upon the size and surface area of sprinkled or sprayed particles of the sodium hypochlorite water solution. This characteristic can be utilized for pH value adjustment of the sterile water.

In addition to the supply, by sprinkling, of the sodium hypochlorite water solution to the gas-phase region in the carbon dioxide-filled vessel, the sodium hypochlorite water solution may be supplied directly to the liquid-phase region. In this case, the sterile water can be adjusted in pH value by controlling the rate at which the sodium hypochlorite water solution is supplied by sprinkling to the gas-phase region and that at which the sodium hypochlorite water solution is supplied directly to the liquid-phase region.

To produce the sterile water containing hypochlorous or chlorous acid as its major component, an acid other than carbonic acid may additionally be used. In this case, the additional acid may be added either simultaneously with, or after, the contact between the sodium hypochlorite water solution and carbon dioxide.

In case a pressure vessel capable of keeping the liquid level within a constant range is used as the above-mentioned vessel, it can be adapted to function as an accumulator. Using carbonated water produced by putting carbon dioxide and water into contact with each other at site in case the produced sterile water is diluted for use, the sterile water can be diluted with suppression of the variation in pH value thereof.

The foregoing and other features, aspects and advantages of the present invention will be come apparent from the following detailed description of the present invention when taken in conjunction with the accompanying drawings.

### BRIEF DESCRIPTION OF THE DRAWINGS

FIG. 1 is a system construction of the sterile water producing apparatus as a first embodiment of the present invention.

FIG. 2 schematically illustrates the construction of the first embodiment in FIG. 1.

FIG. 3 schematically illustrates the construction of a sterile water producing apparatus as a second embodiment of the present invention.

FIG. 4 schematically illustrates the construction of a sterile water producing apparatus as a third embodiment of the present invention.

FIG. 5 schematically illustrates the construction of a sterile water producing apparatus as a fourth embodiment of the present invention

FIG. 6 schematically illustrates the construction of a sterile water producing apparatus as a fifth embodiment of the present invention.

FIG. 7 schematically illustrates the construction of a variant of the fifth embodiment in FIG. 6.

FIG. 8 schematically illustrates the construction of a sterile water producing apparatus as a sixth embodiment of the present invention

FIG. 9 schematically illustrates the construction of a sterile water producing apparatus as a seventh embodiment of the present invention.

FIG. 10 schematically illustrates the construction of a sterile water producing apparatus as an eighth embodiment of the present invention.

FIG. 11 schematically illustrates the construction of a sterile water producing apparatus as a ninth embodiment of the present invention.

FIG. 12 schematically illustrates the construction of a sterile water producing apparatus as a tenth embodiment of the present invention.

FIG. 13 schematically illustrates the construction of a sterile water producing apparatus as an eleventh embodiment of the present invention.

FIG. 14 schematically illustrates the construction of a sterile water producing apparatus as a twelfth embodiment of the present invention.

FIG. 15 schematically illustrates the construction of a sterile water producing apparatus as a thirteenth embodiment of the present invention.

FIG. 16 schematically illustrates the construction of a sterile water producing apparatus as a fourteenth embodiment of the present invention.

FIG. 17 schematically illustrates the construction of a sterile water producing apparatus as a fifteenth embodiment of the present invention.

FIG. 18 is a sectional view of the pressure vessel, showing a manner in which the sodium hypochlorite water solution or water is introduced into the pressure vessel.

FIG. 19 is also a sectional view of the pressure vessel, showing another manner in which the sodium hypochlorite water solution or water is introduced into the pressure vessel.

FIG. 20 is a sectional view of the pressure vessel, showing still another manner in which the sodium hypochlorite water solution or water is introduced into the pressure vessel.

FIG. 21 explains one manner in which the sodium hypochlorite water solution is bubbled within the pressure vessel.

FIG. 22 explains another manner in which the sodium hypochlorite water solution is bubbled within the pressure vessel.

FIG. 23 explains still another manner in which the sodium hypochlorite water solution is bubbled within the pressure vessel.

### DETAILED DESCRIPTION OF THE INVENTION

The present invention will be described in detail below concerning the embodiments thereof for producing sterile water containing hypochlorous acid as its major component is produced with reference to the accompanying drawings. However, the following description is also true with possible embodiments of the present invention for producing sterile water containing chlorous acid as a major component.

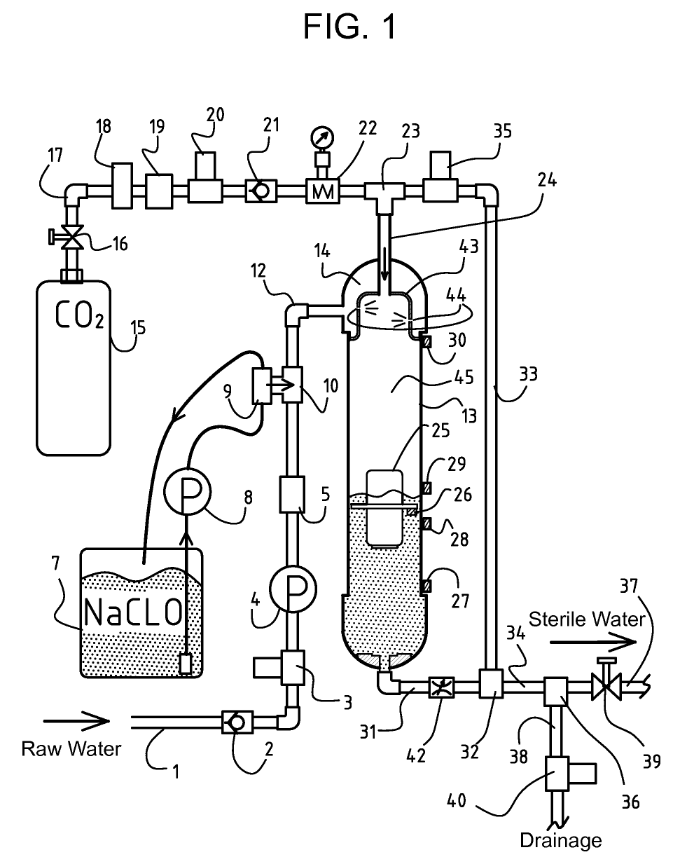

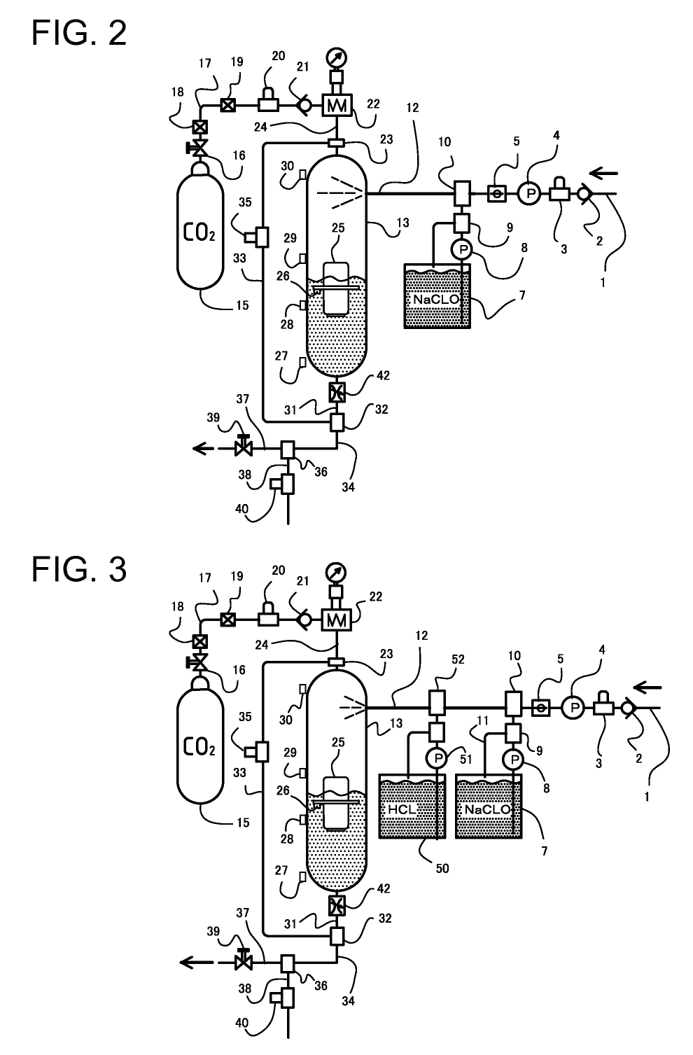

### FIRST EMBODIMENT (FIGS. 1 and 2)

FIG. 1 illustrates the sterile water producing apparatus as the first embodiment of the present invention, and FIG. 2 schematically illustrates the construction of the first embodiment in FIG. 1. The reference numeral 1 indicates a raw water supply pipe. The raw water may be tap water, well water or seawater. The raw water supply pipe 1 has provided therein a check valve 2, motor-operated valve 3, pump 4 and flowmeter 5. The pump 4 for supplying the raw water under pressure may be omitted in case raw water supplied under pressure such as tap water is used. The reference numeral 7 indicates a material tank 7 in which an sodium hypochlorite water solution is retained, and 8 a pump. The sodium hypochlorite water solution in the material tank 7 is supplied through a passage selection valve 9 to an addition unit 10 in which it will be mixed with the raw water. The sodium hypochlorite water solution diluted to a desired concentration by mixing with the raw water is supplied to an upper space 14 in a pressure vessel 13 (pressure tank) through a raw material supply pipe 12.

The reference numeral 15 indicates a carbon dioxide (CO₂) cylinder When a manual valve 16 is opened, the carbon dioxide in the carbon dioxide cylinder 15 is supplied to the pressure vessel 13 through a carbon dioxide supply pipe 17. The reference numerals 18 and 19 indicate reducing valves. These two reducing valves 18 and 19 are used to supply about 1 to 3 kg/cm² of carbon dioxide to the pressure vessel 13. The reference numeral 20 indicates a motor-operated valve, 21 a check valve, 22 a pressure gauge and 23 a branch pipe. A gas introduction pipe 24 is also provided to introduce the carbon dioxide into the pressure vessel 13. Also, the pressure inside the pressure vessel 13 is detected by the pressure gauge 22.

The reference numeral 25 indicates a float, and 26 a magnet installed to the float 25. On the side wall of the pressure vessel 13, there are provided discretely along the length of the vessel 13 four limit switches 27 to 30 which detect the liquid levels in the pressure vessel 13. The magnet 26 and limit switches 27 to 30 form together a liquid level detector that detects the liquid level in the pressure vessel 13. Otherwise, a liquid level monitoring tube such as a transparent glass tube, having a float provided therein, may be provided to extend vertically outside the pressure vessel 13. The level of the liquid inside the pressure vessel 13 will be known by reading the level of the float in the monitoring tube.

The pressure vessel 13 has a discharge pipe 31 connected to the bottom thereof. The reference numeral 32 indicates a first branch pipe. The discharge pipe 31 is connected to first and second pipes 33 and 34. The first pipe 33 is connected to the above-mentioned branch pipe 23. The reference numeral 35 indicates a motor-operated valve. The discharge pipe 31 is preferably a small diameter one or provided with a throttle valve 42.

The second pipe 34 is branched by a second branch pipe 36 to a sterile water delivery pipe 37 and drain pipe 38. The reference numeral 39 indicates a manual or motor-operated valve provided in the sterile water delivery pipe 37, and 40 a motor-operated valve provided in the drain pipe 38. A passage selection valve may be provided in the sterile water delivery pipe 37 in place of the motor-operated valve 40 in the drain pipe 38 to make a selection between a drain mode in which the drain pipe 38 is to be opened or a sterile water delivery mode in which the sterile water delivery pipe is 37 is to be opened.

In the upper portion of the pressure vessel 13, there is disposed a partition 43 having a plurality of small holes 44 formed therein. The partition 43 segmentizes an upper space 14 to which the sodium hypochlorite water solution is supplied and a main space 45 to which carbon dioxide is supplied through the gas introduction pipe 24. The sterile water producing apparatus constructed as above operates as will be explained below.

The operation of the sterile water producing apparatus as the first embodiment of the present invention will be outlined below. The pressure vessel 13 is filled with carbon dioxide under a predetermined pressure. An sodium hypochlorite water solution adjusted in concentration to a predetermined value is supplied to the carbon dioxide in the pressure vessel 13. The carbon dioxide will be dissolved into the sodium hypochlorite water solution. The extent of dissolution of the carbon dioxide can be adjusted correspondingly to a manner in which the sodium hypochlorite water solution is supplied, that is, to the size or surface area of the particles of the sprinkled sodium hypochlorite water solution. As will be known from comparison between the supply, by shower-like sprinkling, and that by atomization by a spray nozzle, of the sodium hypochlorite water solution, for example, the supply by atomization assures a higher efficiency of the dissolution of the carbon dioxide into the solution. Also, the carbon dioxide will be dissolved in a larger amount when the pressure in the pressure vessel 13 is set higher. These are matters of design choice. Even if the carbon dioxide has been dissolved up to the level of saturation, the sterile water (carbonated water) thereby produced in the pressure vessel 13 does not enter into the strongly acidic region.

Preparation Mode:

The valve 20 for supplying carbon dioxide and valve 39 provided in the sterile water delivery pipe 37 are closed. On the other hand, the valve 35 provided in the pipe 33 and valve 40 provided in the drain pipe 38 are opened. Next, a sodium hypochlorite water solution is supplied to the upper space 14 and strongly sprayed to the main space 45 through the small holes 44. Preferably, the flows of the sodium hypochlorite water solution sprayed through the small holes 44 are brought into collision with each other for atomization.

The flow rate of raw water used to dilute the sodium hypochlorite water solution is detected by the flowmeter 5. The sodium hypochlorite water solution in the material tank 7 is supplied by the pump 8 to the addition block 10 at a rate corresponding to the detected flow rate. The sodium hypochlorite water solution is mixed with the raw water to have a predetermined concentration corresponding to an intended use. The sodium hypochlorite water solution thus adjusted in concentration is supplied to the pressure vessel 13 through the material supply pipe 12.

Since the throttle valve 42 is provided in the discharge pipe 31 connected to the bottom of the pressure vessel 13, the liquid level in the pressure vessel 13 supplied with the sodium hypochlorite water solution is raised. As the liquid level rises, air in the pressure vessel 13 enters the gas introduction pipe 24 and is then released to outside through the branch pipe 23, first pipe 33, second pipe 34 and drain pipe 38.

When the float 25 goes up as the liquid level rises until the uppermost limit switch 30 detects the liquid level, the valve 35 provided in the first pipe 33 to discharge air in the pressure valve 13 to outside is opened. On the other hand, the valve 20 for supplying the carbon dioxide is opened and thus carbon dioxide under a relatively low pressure attained using the two reducing valves 18 and 19 is supplied from the carbon dioxide cylinder 15 to the pressure vessel 13 through the gas introduction pipe 24. Such control is made by a controller (not shown).

To discharge air in the pressure vessel 13 to outside in the preparation mode, an air purge valve may be provided at or near the top of the pressure vessel 13, which can be opened for purging the air in the pressure vessel 13 to outside. When the air has completely been purged out of the pressure vessel 13, namely, when the liquid level in the pressure vessel 13 rises until it is detected by the uppermost limit switch 30, the air purge valve is to be closed. In this case, the discharge pipe 33 and valve 35 may be omitted.

As the pressure in the pressure vessel 13 having been supplied with the carbon dioxide rises, the liquid level in the pressure vessel 13 will gradually be lower. When the liquid level is lowered until it is detected by the second limit switch 28, the valve 20 for supplying the carbon dioxide and valve 40 provided in the drain pipe 38 will be closed. Thus, the liquid level will rise again.

The pressure in the pressure vessel 13 is monitored by the pressure gauge 22. When the pressure in the pressure vessel 13 becomes higher than a predetermined value or when the third limit switch 29 detects the liquid level, the pump 4 provided in the raw water supply pipe 1 is stopped from running, and the valve 3 provided in the raw water supply pipe 1 is preferably closed. With the above operations, a blue lamp (not shown), for example, is illuminated to inform that the sterile water producing apparatus is ready for delivery of the sterile water for use.

In the above preparation mode, since the atomized sodium hypochlorite water solution is sprayed into the pressure vessel 13 filled with the carbon dioxide, the carbon dioxide is dissolved into the sodium hypochlorite water solution to automatically lower the pH value of the sodium hypochlorite water solution to a level at which the solution is acidic, whereby sterile water containing hypochlorous acid as a major component can be produced. Since the carbonated water resulted from the dissolution of the carbon dioxide into water is weak-acidic, the sterile water produced in the pressure vessel 13 filled with the carbon dioxide will not possibly have the pH value thereof lowered to a level at which the sterile water is strong-acidic.

In this connection, sodium hydrogen carbonate is known as a substance having a buffering effect. Addition of the sodium hydrogen carbonate to the sodium hypochlorite water solution permits to lower the susceptibility to acid. However, the sodium hydrogen carbonate is disadvantageous in that it ceaselessly emits carbon dioxide and becomes lower in the buffering effect. For this reason, a job or device is required to periodically or always replenish the sodium hydrogen carbonate. According to the embodiment, such a job or device is not required since the sterile water is produced in the pressure vessel 13 filled with the carbon dioxide.

Operation Mode:

When the above-mentioned preparation mode is complete, the sterile water producing apparatus is switched to an operation mode in which it can readily deliver the sterile water having been adjusted in pH value by dissolving the carbon dioxide into the sodium hypochlorite water solution. The manual or motor-operated valve 39 provided in the sterile water delivery pipe 37 is opened to deliver the sterile water for use. As the sterile water is used, the liquid level in the pressure vessel 13 falls. When the second limit switch 28 detects the liquid level, the motor-operated valve 3 provided in the raw water supply pipe 1 is opened, the pump 4 is put into operation again and the pressure vessel 13 is supplied with the sodium hypochlorite water solution having been diluted to the predetermined concentration. The concentration of the sodium hypochlorite water solution supplied to the pressure vessel 13 can be adjusted by controlling the rate at which the sodium hypochlorite water solution in the material tank 7 is added to the raw water through the addition unit 10.

When the liquid level in the pressure vessel 13 rises until it is detected by the third limit switch 29, the valve 20 provided in the carbon dioxide supply pipe 17 is opened and the carbon dioxide is supplied to the pressure vessel 13. Thus, the pressure in the pressure vessel 13 rises, while the liquid level in the pressure vessel 13 falls. When the second limit switch 28 detects the liquid level, the valve 20 for supplying the carbon dioxide is closed to stop supply of the carbon dioxide to the pressure vessel 13. The carbon dioxide in the pressure vessel 13 will be absorbed by the sodium hypochlorite water solution injected into the pressure vessel 13, and thus the pressure inside the pressure vessel 13 will gradually fall.

By repeatedly effecting and ceasing the supply of the carbon dioxide to the pressure vessel 13, the pressure in the pressure vessel 13 is kept within a constant range while the level of the sterile water is kept between the second and third limit switches 28 and 29. In this connection, if the pressure in the pressure vessel 13 is too high, the carbon dioxide is actively dissolved inside the pressure vessel 13. If the carbon dioxide is dissolved more than necessary, the pH value of the sterile water in the pressure vessel 13 will possibly vary.

Also, when the sterile water delivery is reduced by partially or fully closing the manual or motor-operated valve 39, the sodium hypochlorite water solution will be supplied to the pressure vessel 13 in a larger amount than the sterile water delivery from the pressure vessel 13, so that although the carbon dioxide is supplied by opening the valve 20, the pressure in the pressure vessel 13 will be raised with rise of the liquid level in the pressure vessel 13. When the pressure gauge 22 detects a pressure higher than a predetermined one in the pressure vessel 13, the raw water supply pump 4 is stopped from running, and the motor-operated valve 3 is preferably be closed to stop supply of the sodium hypochlorite water solution to the pressure vessel 13. Then, when the sterile water is used until the second limit switch 28 detects the liquid level in the pressure vessel 13, the pump 4 is put into operation again and the motor-operated valve 3 is opened to resume supply of the raw water, whereby the liquid level in the pressure vessel 13 will be kept within a constant range. That is, by repeatedly effecting and ceasing the supply of the sodium hypochlorite water solution to the pressure vessel 13, the liquid level of the sterile water in the pressure vessel 13 is kept within a constant range.

Therefore, even if a small amount of the sterile water is continuously delivered or if delivery of the sterile water is repeatedly effected and ceased, the sterile water producing apparatus can produce the sterile water stably without having to additionally provide any equipment such as a separate accumulator. That is, the pressure vessel 13 that uses the carbon dioxide for production of the sterile water containing hypochlorous acid as its major component works as an accumulator.

Note here that if the liquid level in the pressure vessel 13 has risen abnormally so that the internal pressure in the pressure vessel 13 will not exceed the predetermined value even when the uppermost limit switch 30 has detected the liquid level, for example, it may be considered that the carbon dioxide cylinder 15 has become empty. To give an alarm in such a case, the sterile water producing apparatus is preferably equipped with a device that gives an audible alarm and/or a red lamp (not shown) that is turned on to give a visual alarm. Of course, the apparatus is preferably provided with a device to give an alarm when the pressure gauge 22 detects that the pressure in the pressure vessel 13 has abnormally fallen.

In the above embodiment, when the pressure in the pressure vessel 13 exceeds a predetermined one, supply of the raw water is stopped by stopping the pump 4 from running and preferably by closing the motor-operated valve 3. In a variant of this embodiment, a limit switch (not shown) is additionally provided between the third and uppermost limit switches 29 and 30 to stop the raw water supply by stopping the pump 4 from running and preferably by closing the motor-operated valve 3 when the additional limit switch detects the liquid level.

The passage selection valve 9 provided at the addition unit 10 makes a selection between the passages at every predetermined time, for example, to return the sodium hypochlorite water solution drawn up by the pump 8 from the material tank 7 to the material tank 7. Thus, it is possible to remove air bubbles formed in the sodium hypochlorite water solution supply passage extending from the material tank 7 to the addition unit 10.

The sterile water producing apparatus is preferably designed so that it can not only control the amount of the sodium hypochlorite water solution to be added to the raw water in the addition unit 10 in response to the flow amount of the raw water, but also change the concentration of the sodium hypochlorite water solution for supply to the pressure vessel 13 by adjusting the added amount of the raw water. When the target concentration of the sodium hypochlorite water solution has been changed, it is recommended to interrupt the supply of the sterile water produced in the pressure vessel 13 for a while and to set the apparatus in an automatic driving mode including opening the valve 40 of the drain pipe 38 and discharging the sterile water from the pressure vessel 13 until the target concentration is attained.

The present invention will further be explained below concerning various other embodiments thereof with reference to FIG. 3. The elements same as or similar to those in the first embodiment will be indicated with the reference numerals same as or similar to those used in the explanation of the first embodiment and hence will not be explained any longer. Features of the embodiments in consideration will mainly be described.

### SECOND EMBODIMENT (FIG. 3)

In the second embodiment, one of acids including inorganic acids such as hydrochloric acid, sulfuric acid and the like or organic acids such as acetic acid, lactic acid and the like, other than carbonic acid, is mixed with the sodium hypochlorite water solution. Typical one of such acids is water-diluted hydrochloric acid. More specifically, the sterile water producing apparatus as the second apparatus includes an additional material tank 50 in which an acid such as dilute hydrochloric acid is filled. The acid in the additional material tank 50 is supplied by an additional pump 51 to the material supply pipe 12 or raw water supply pipe 1 and mixed with the sodium hypochlorite water solution in an additional addition unit 52 to pre-adjust the pH value of the sodium hypochlorite water solution to be supplied to the pressure vessel 13.

The pH pre-adjustment may be a preliminary adjustment of the pH value of the sodium hypochlorite water solution to weak alkalinity or preferably to neutrality or an adjustment to lower the pH value of the sodium hypochlorite water solution to near a final target pH value (pH 6 for example), both effected before a final pH adjustment with carbon dioxide in the pressure vessel 13. Both the pH adjustment including both the preliminary pH adjustment of the sodium hypochlorite water solution with an acidic component (typically, hydrochloric acid) other than carbonated water and the pH adjustment to lower the pH value to near the final target pH value with the acidic component (typically, hydrochloric acid) other than the carbonated water will be referred to herein as “auxiliary pH adjustment”.

In the aforementioned first embodiment (see FIGS. 1 and 2), the carbon dioxide is used to adjust the pH value of the sodium hypochlorite water solution. The pH adjustment with the carbon dioxide as in the first embodiment is suitable for producing and delivering sterile water while a large quantity of foodstuff such as vegetable or meat is washed with the delivered sterile water.

On the other hand, the pH adjustment of the sodium hypochlorite water solution with the combination of acid such as dilute hydrochloric acid and carbonated water as in the second embodiment (see FIG. 3) is suitable for producing sterile water which is to be used for space sterilization, for example. More specifically, for the space sterilization, the sterile water is typically sprayed as two fluids formed by compressed air or sprinkled after atomized by supersonic vibration. The two-fluid spraying has no problem, but when the sterile water is atomized by the supersonic vibration, the dissolved carbon dioxide will be gasified and get out of the sterile water with the result that the pH value of the sterile water will possibly be higher. On the other hand, if the sterile water contains any dilute hydrochloric acid, the latter will permit to prevent the pH value of the sterile water from which the carbon dioxide has gone out from being elevated to the level of alkalinity. This is also true with the produced sterile water stored for a long term. Namely, even if the carbon dioxide has gotten out of the sterile water in storage, the sterile water can be prevented by hydrochloric acid from becoming alkaline. Therefore, the second embodiment is advantageous in that the sterile water can have the pH value thereof stabilized by the hydrochloric acid included therein.

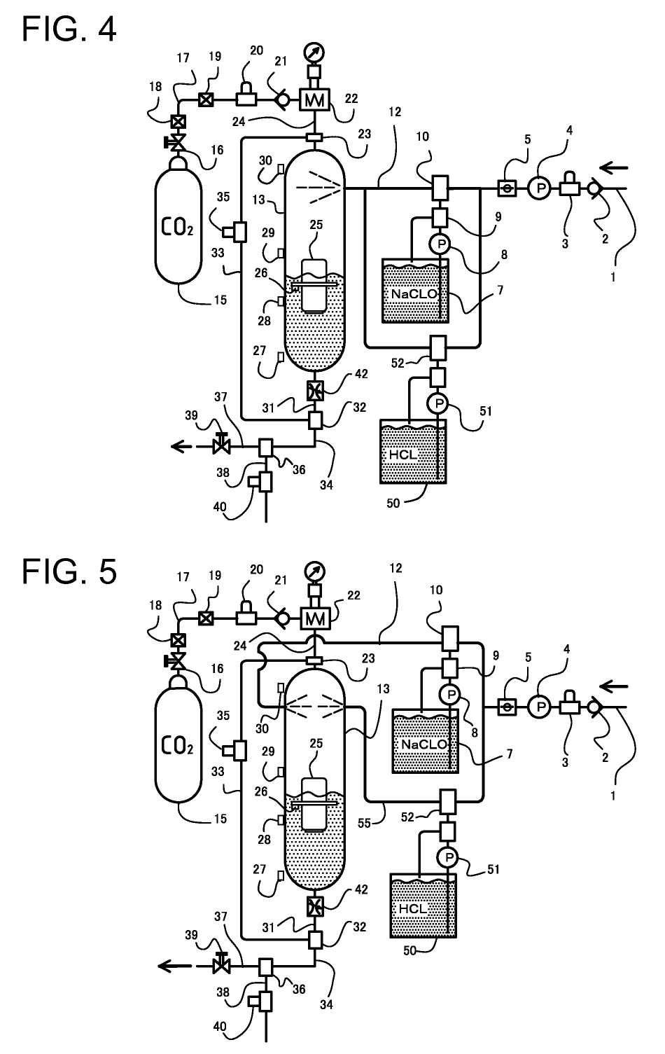

### THIRD EMBODIMENT (FIG. 4)

The third embodiment is also a variant of the second embodiment. In the second embodiment, the addition unit 10 for addition of the sodium hypochlorite water solution and the additional addition unit 52 for addition of acid are disposed in series with each other. However, the addition units 10 and 52 may be disposed in parallel with each other as in the third embodiment as shown in FIG. 4. That is, the sodium hypochlorite water solution and dilute hydrochloric acid may be added separately, then they be mixed together to make auxiliary pH adjustment of the sodium hypochlorite water solution, and the sodium hypochlorite water solution thus subjected to the auxiliary pH adjustment be supplied to the pressure vessel 13.

### FOURTH EMBODIMENT (FIG. 5)

The fourth embodiment is also a variant of the third embodiment. In the third embodiment, the sodium hypochlorite water solution is subjected to the auxiliary pH adjustment before supplied to the pressure vessel 13. However, hydrochloric acid having been diluted to a predetermined concentration may be supplied directly to the pressure vessel 13 along a different route 55 as in the fourth embodiment. The hydrochloric acid may be supplied to the liquid-phase region in the pressure vessel 13. Preferably, the hydrochloric acid is atomized by sprinkling or spraying it to an upper portion of the pressure vessel 13. Most preferably, the hydrochloric acid is sprinkled or sprayed to get into collision with particles of the sodium hypochlorite water solution sprinkled or sprayed in the pressure vessel 13 and the sodium hypochlorite water solution and dilute hydrochloric acid be mixed together in the gas-phase region in the pressure vessel 13, to thereby produce the sterile water in the pressure vessel 13 filled with the carbon dioxide while making the auxiliary pH adjustment of the sodium hypochlorite water solution.

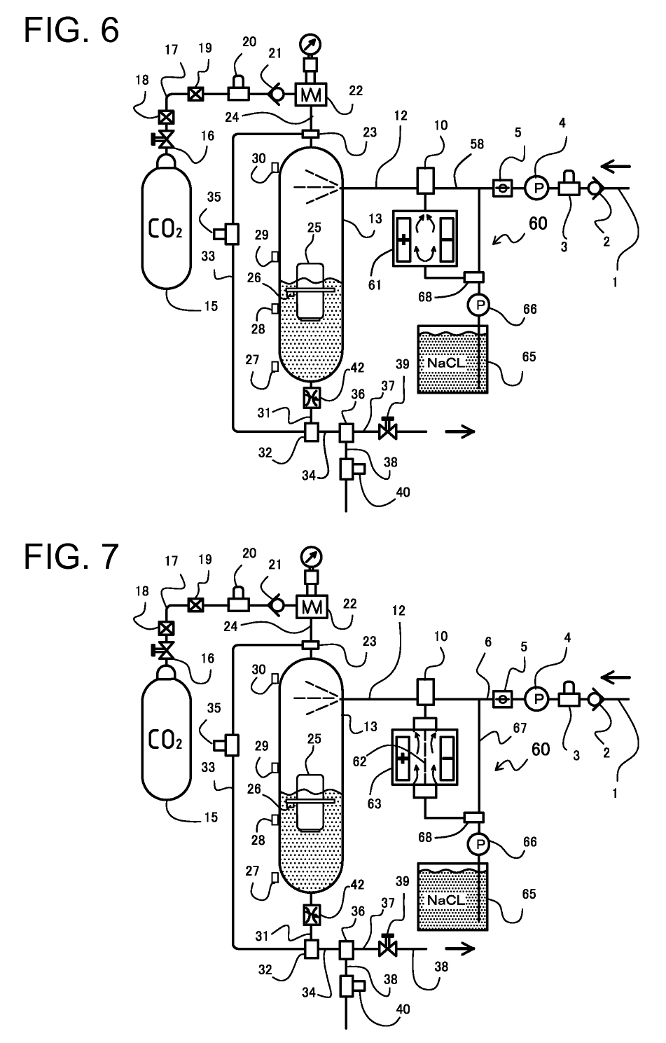

### FIRTH EMBODIMENT (FIGS. 6 and 7)

The aforementioned first and other embodiments use the material tank 7 (see FIG. 1 etc.) in which the sodium hypochlorite water solution is filled. Instead, the fifth embodiment can prepare the sodium hypochlorite water solution in the apparatus to supply the new-made solution to the pressure vessel 13. The reference numeral 60 in FIGS. 6 and 7 indicates a sodium hypochlorite water solution preparation unit.

The sodium hypochlorite water solution preparation unit 60 shown in FIG. 6 includes an electrolytic bath 61 having no membrane. On the other hand, the sodium hypochlorite water solution preparation unit 60 shown in FIG. 7 includes an electrolytic bath 63 having a membrane 62 provided therein.

The reference numeral 65 in FIGS. 6 and 7 indicates a sodium chloride water solution tank, 66 a pump, and 67 a branch pipe of the raw water supply pipe 1. The sodium chloride water solution drawn up by the pump 66 from the sodium chloride water solution tank 65 is mixed with raw water in an addition unit 68 for dilution to a predetermined concentration, and then the resultant mixture is supplied to the electrolytic baths 61 and 63.

The sodium hypochlorite water solution prepared in the electrolytic bath 61 with no membrane (see FIG. 6) is mixed with the raw water in the addition unit 10 for dilution to a predetermined concentration, and then the resultant mixture is supplied to the pressure vessel 13.

Generally in the electrolytic bath 63 with the membrane 62 (see FIG. 7), an electrolytic liquid discharged from the anode side joins one discharged from the cathode side, and this electrolytic liquid mixture is mixed with the raw water in the addition unit 10 for dilution to a predetermined concentration before supply to the pressure vessel 13. However, the electrolytic liquid discharged from the cathode side need not be used entirely but may be discarded partly.

Although a par of the raw water is supplied to the electrolytic baths 61 and 63 at the downstream of the flowmeter 5 as shown in FIGS. 6 and 7, the entirety of the raw water may be supplied to the electrolytic baths 61 and 63. In this case, the fifth embodiment may be adapted to apply a voltage corresponding to the flow rate of the raw water, measured by the flowmeter 51 to the electrolytic baths 61 and 63.

Of course, the fifth embodiment shown in FIGS. 6 and 7 may be adapted to produce the sterile water in the pressure vessel 13 filled with the carbon dioxide while making the auxiliary pH adjustment of the sodium hypochlorite water solution by mixing a dilute acid water solution (typically, dilute hydrochloric acid) into the sodium hypochlorite water solution just before the latter is supplied to the pressure vessel 13 or when it is sprayed into the pressure vessel 13 in the same manner as having previously been described with reference to FIGS. 3 to 5.

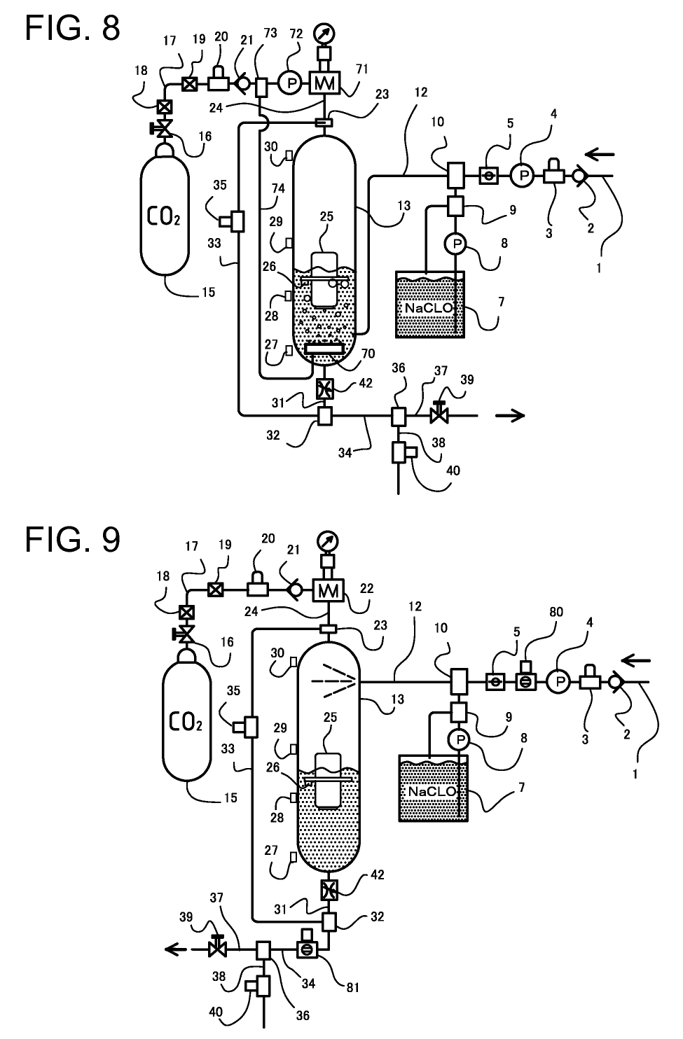

### SIXTH EMBODIMENT (FIG. 8)

In the sixth embodiment, the pH value of the sodium hypochlorite water solution in the pressure vessel 13 is lowered by bubbling the carbon dioxide to produce sterile water containing hypochlorous acid as a major component, as will be seen in FIG. 8. The reference numeral 70 in FIG. 8 indicates a bubble generator typically formed from a porous material and nozzle.

For bubbling the carbon dioxide to adjust the pH value, the sodium hypochlorite water solution may be sprayed or sprinkled in the upper portion of the pressure vessel 13 as in the first embodiment. However, it may be supplied to the bottom of the pressure vessel 13, that is, to the liquid-phase region in the pressure vessel 13. Also, it is of course that dilute hydrochloric acid may be mixed in the sodium hypochlorite water solution as in the embodiments shown in FIGS. 3 to 5 to make the auxiliary pH adjustment.

As shown in FIG. 8, when the pressure in the pressure vessel 13 exceeds a predetermined level, a relief valve 71 is opened and the carbon dioxide is supplied by a pump 72 to a confluence unit 73 where it will join the carbon dioxide supplied from the carbon dioxide (CO₂) cylinder 15. The resultant gas is supplied to the bubble generator 70 through a pipe 74. Thus, the carbon dioxide will be formed into fine bubbles in the liquid-phase region (sterile water) in the pressure vessel 13. Being thus bubbled, the carbon dioxide is dissolved into the sodium hypochlorite water solution in the pressure vessel 13 and thus the pH value of the solution is adjusted.

### SEVENTH EMBODIMENT (FIG. 9)

As shown in FIG. 9, the seventh embodiment is characterized by a mechanism for keeping the liquid level in the pressure vessel 13 within a predetermined range. The liquid level keeping mechanism includes a first motor-operated flow control valve 80 provided in the raw water supply pipe 1 and a second motor-operated flow control valve 81 provided at the delivery side of the pressure vessel 13.

When the liquid level in the pressure vessel 13 is lowered until it is detected by the second limit switch 28, the second flow control valve 81 is activated to reduce the delivery rate of the sterile water from the pressure vessel 13.

When the liquid level in the pressure vessel 13 is raised until it is detected by the third limit switch 29, the flow control valve 81 provided at the delivery side of the pressure vessel 13 is returned to its original opening to allow the pressure vessel 13 to deliver an increased amount of the sterile water, white the first flow control valve 80 provided in the raw water supply pipe 1 is activated to reduce the rate at which the sodium hypochlorite water solution is supplied to the pressure vessel 13. With these operations, the liquid level in the pressure vessel 13 can be maintained between the second and third limit switches 28 and 29.

In case the system is designed such that the liquid level in the pressure vessel 13 is lowered when both the first and second flow control valves 80 and 81 are fully opened, the liquid level can be maintained within a constant range only by adjusting the second flow control vale 81 at the delivery side. On the contrary, in case the system is designed so that when both the first and second flow control valves 80 and 81 are fully opened, the liquid level in the pressure vessel 13 is raised, the liquid level can be maintained within a constant range only by adjusting the first flow control valve 80 in the raw water supply pipe 1.

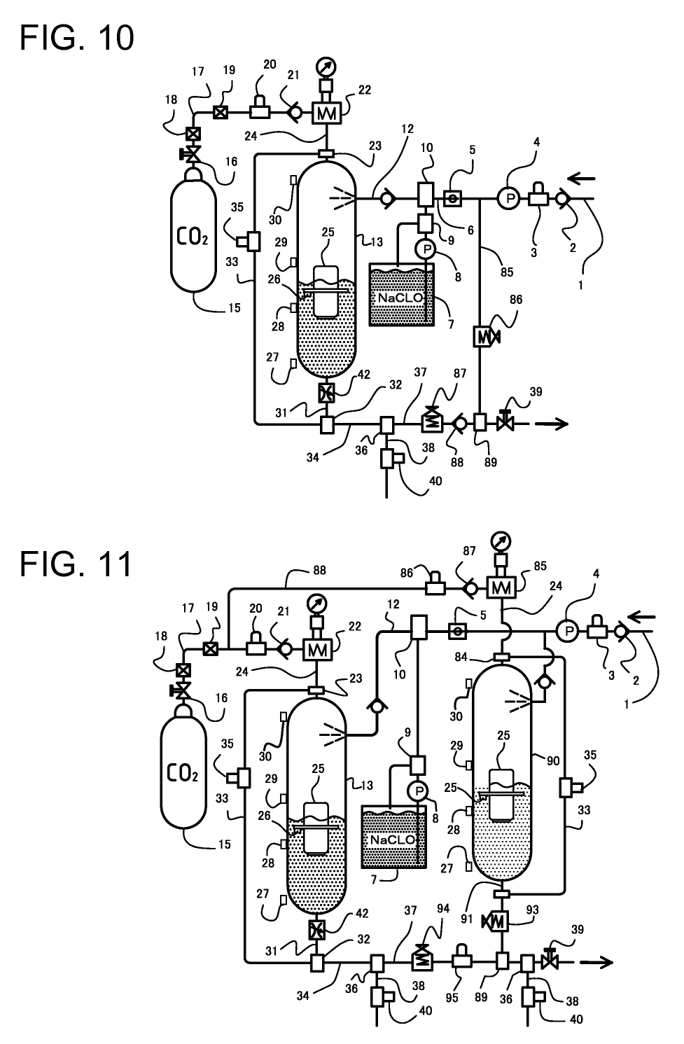

### EIGHTH EMBODIMENT (FIG. 10)

The eighth embodiment shown in FIG. 10 is suitable for diluting the sterile water produced in the pressure vessel 13 with the raw water before delivery for use.

As shown in FIG. 10, a raw water distribution pipe 85 is connected between the raw water supply pipe 1 and sterile water delivery pipe 37. Thus, a part of the raw water can be added to the sterile water produced in the pressure vessel 13 to lower the concentration of the sterile water. The reference numerals 86 and 87 in FIG. 10 indicate reducing valves and 88 a check valve. The amount of the raw water to be supplied to the sterile water delivery pipe 37 can be adjusted in a confluence unit 89 to provide the sterile water having a desired concentration.

### NINTH EMBODIMENT (FIG. 11)

The ninth embodiment shown in FIG. 11 is suitable for diluting the sterile water produced in the pressure vessel 13 before delivery for use similarly to the eighth embodiment (see FIG. 10).

As shown in FIG. 11, in addition to the first pressure vessel 13 in which the sterile water containing hypochlorous acid as its major component is produced, there is provided a second pressure vessel 90 having a substantially same construction as the pressure vessel 13 and in which carbonated water is produced. By diluting the sterile water with the carbonated water, the pH value can be limited from being varied due to the dilution of the sterile water.

The second pressure vessel 90 to produce the carbonated water is provided with limit switches (liquid-level switch) 27 to 30 to maintain the liquid level between the second and third limit switches 28 and 29 as at the first pressure vessel 13. The carbonated water produced in the second pressure vessel 90 is discharged from a discharge pipe 91 and added to the sterile water in the confluence unit 89. The addition of the carbonated water, that is, dilution of the sterile water, will be adjusted in the confluence unit 89. In FIG. 11, the reference numerals 93 and 94 indicate reducing valves and 95 a motor-operated valve.

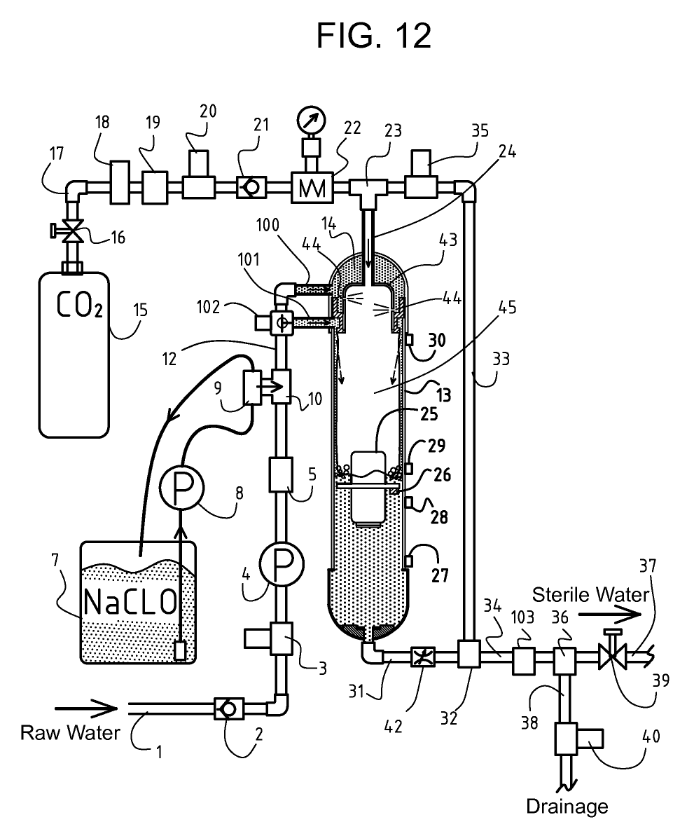

### TENTH EMBODIMENT (FIG. 12)

In the first to ninth embodiments, the carbon dioxide is used to adjust the pH value of the sterile water. The tenth embodiment is an improved version of the first to ninth embodiments, and the improvement is also applicable to the latter.

As shown in FIG. 12, the sodium hypochlorite water solution is added, in the confluence unit 10, to the raw water supplied through the raw water supply pipe 1 to produce a sodium hypochlorite water solution having a desired concentration. Then, the sodium hypochlorite water solution is supplied to the pressure vessel 13 through first and second branch pipes 100 and 101 of the material supply pipe 12. The ratio between the sodium hypochlorite water solution supplied through the first branch pipe 100 and that through the second branch pipe 101 can freely be adjusted using a distribution valve 102.

The first branch pipe 100 is connected to the aforementioned upper space 14 in the pressure vessel 13, and the sodium hypochlorite water solution passing through the first branch pipe 100 is sprayed or sprinkled to the main space 45 through the small holes 44. On the other hand, the second branch pipe 101 is connected to the main space 45 in the pressure vessel 13, and the sodium hypochlorite water solution passing through the second branch pipe 101 falls as a flow into the main space 45. The reference numeral 103 in FIG. 12 indicates a pH meter. In this connection, since the concentration of the carbon dioxide can substantially be known by detecting dissolved carbon dioxide in the carbonate water, the pH value of the sterile water can be known indirectly. Therefore, the pH meter 103 may be a dissolved carbon-dioxide concentration meter to detect the concentration of the dissolved carbon dioxide in the sterile water.

By changing, by the distribution valve 12, the ratio between the rate at which the sodium hypochlorite water solution is sprinkled or spayed into the pressure vessel 13 and rate at which the solution is allowed to fall as a flow into the pressure vessel 13, it is possible to change the extent of contact between the sodium hypochlorite water solution and carbon dioxide inside the pressure vessel 13. Thus, feedback control can be made for the pH value of the sterile water in the pressure vessel 13 to become a target one.

It is assumed here the pH value of the sterile water produced in the pressure vessel 13 is set “6”, for example. In case a pH value detected by the pH meter 103 is larger than “6”, the rate at which the sodium hypochlorite water solution sprayed into the pressure vessel 13 through the first branch pipe 100 can be increased to lower the pH value of the sterile water toward a target value. On the other hand, in case the detected pH value is smaller than “6”, the rate at which the sodium hypochlorite water solution sprayed into the pressure vessel 13 through the first branch pipe 100 can be decreased to raise the pH value of the sterile water toward the target value. Such control is made by a controller (not shown).

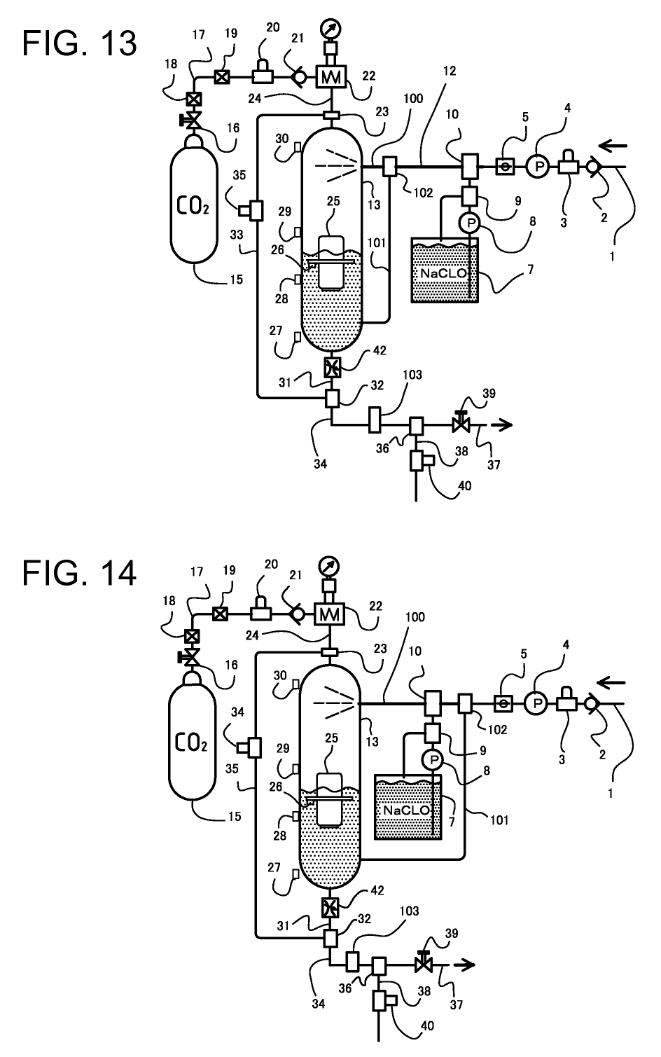

It is of course that the distribution valve 102 may be formed from a manual valve, for example. In this case, the ratio between the rate at which the sodium hypochlorite water solution is sprinkled or spayed into the pressure vessel 13 and rate at which the solution is allowed to fall as a flow into the pressure vessel 13 will substantially be fixed. This is also true with eleventh to fourteenth embodiments which will be explained below with reference to FIGS. 13 to 16.

### ELEVENTH EMBODIMENTt (FIG. 13)

The eleventh embodiment shown in FIG. 13 is also a variant of the above-mentioned tenth embodiment shown in FIG. 12. In the tenth embodiment (as in FIG. 12), the second branch pipe 101 is open at the top of the main space 45 of the pressure vessel 13. In the eleventh embodiment, however, the second branch pipe 101 is open at the bottom, namely, in the liquid-phase region, of the pressure vessel 13.

### TWELFTH EMBODIMENT (FIG. 14)

The twelfth embodiment shown in FIG. 14 is also a variant of the above-mentioned tenth embodiment (as in FIG. 12) and eleventh embodiment (as in FIG. 13). In the tenth and eleventh embodiments, the distribution valve 102 is disposed downstream of the addition unit 10. In the twelfth embodiment, however, the distribution valve 102 is disposed upstream of the addition unit 10 to supply the raw water to the pressure vessel 13 as shown in FIG. 14. Although the raw water is supplied to the bottom, namely, to the liquid-phase region, of the pressure vessel 13 as shown in FIG. 14, the raw water may be supplied to the upper portion of the pressure vessel 13 to fall as a flow as in the tenth embodiment. Also in the twelfth embodiment, the pH value of the sterile water produced in the pressure vessel 13 can be adjusted to a freely set target value.

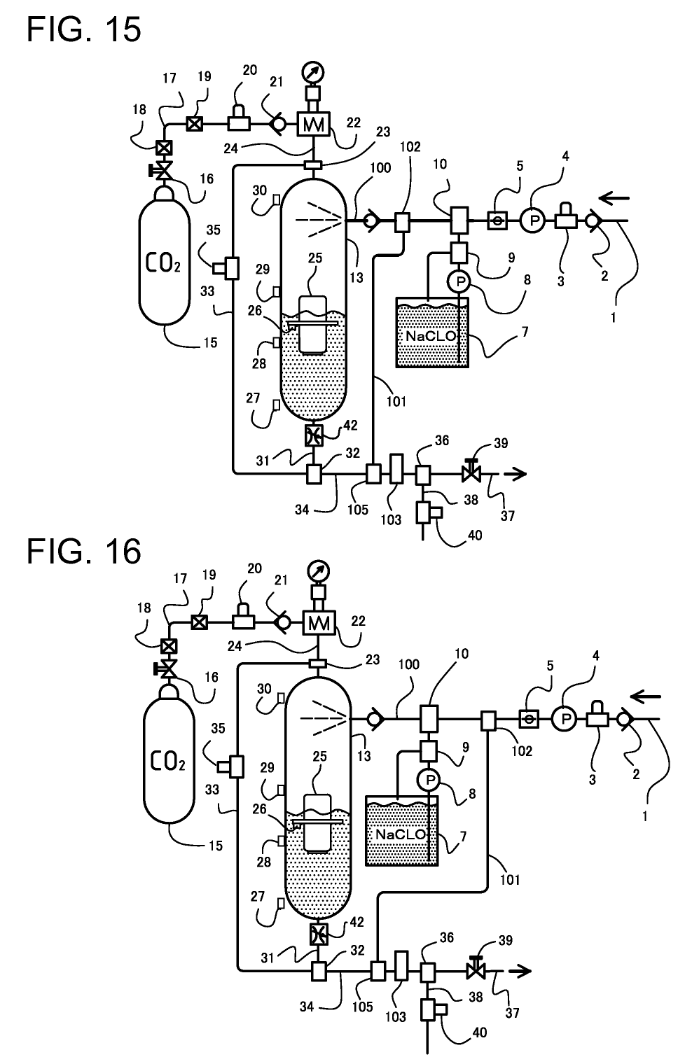

### THIRTEENTH EMBODIMENT (FIG. 15)

In this thirteenth embodiment, the sodium hypochlorite water solution is added to the sterile water produced in the pressure vessel 13 and containing hypochlorous acid as the major component to control the pH value of the sterile water. As shown in FIG. 15, the distribution valve 102 is disposed downstream of the addition unit 10 so that a part of the sodium hypochlorite water solution having been adjusted in concentration will be sprayed or sprinkled into the pressure vessel 13 through the first branch pipe 100 and the remainder of that sodium hypochlorite water solution be supplied to the sterile water delivery side. The reference numeral 105 indicates a mixing unit. The sterile water produced in the pressure vessel 13 is delivered from the pressure vessel 13 and then has the sodium hypochlorite water solution added thereto in the mixing unit 105.

By adding the sodium hypochlorite water solution to the sterile water of which the pH value has been adjusted with the carbon dioxide before delivery, it is possible to adjust the pH value of the sterile water. Also, by controlling the rate at which the sodium hypochlorite water solution is added to the sterile water, it is possible to adjust the pH value of the sterile water to a desired target value.

### FOURTEENTH EMBODIMENT (FIG. 16)

The fourteenth embodiment is also a variant of the above-mentioned thirteenth embodiment shown in FIG. 15. As shown in FIG. 16, the distribution valve 102 is disposed upstream of the addition unit 10 so that a part of the raw water will be supplied to the sterile water delivery side and the sterile water produced in the pressure vessel 13 having been delivered from the pressure vessel 13 will have the raw water added thereto in the addition unit 105. This system construction is substantially the same as that of the aforementioned eighth embodiment shown in FIG. 10. Thus, the concentration of the sterile water produced in the pressure vessel 13 can be diluted with the raw water to make fine adjustment of the pH value of the sterile water. The pH value of the sterile water having had the raw water added thereto is detected by the pH meter 103, and the detected pH value is compared with a target value to control the rate at which the raw water is added to the sterile water.

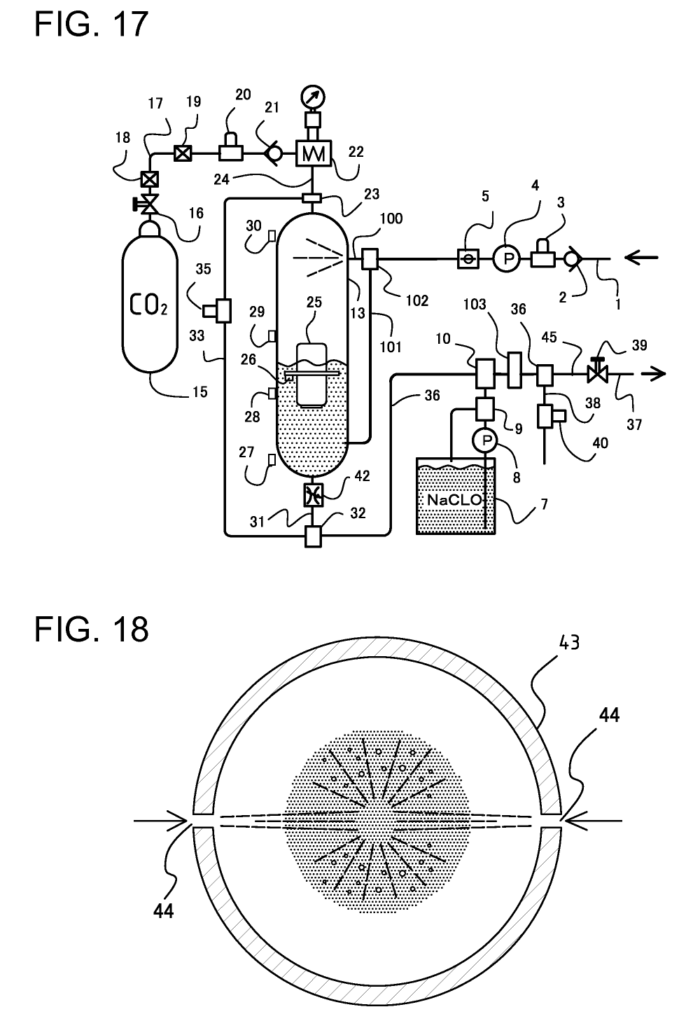

### FIFTEENTH EMBODIMENT (FIG. 17)

In the aforementioned first to fourteenth embodiments, the sterile water containing hypochlorous acid as its major component is produced in the pressure vessel 13. In this fifteenth embodiment, however, it is proposed to the sterile water containing hypochlorous acid as a major component by adding carbonated water to the sodium hypochlorite water solution.

As shown in FIG. 17, the pressure vessel 13 is supplied with only the raw water. That is, the sodium hypochlorite water solution is not supplied to the raw water supply pipe 1. The other construction, associated with the pressure vessel 13, of this fifteenth embodiment is similar to that of the eleventh embodiment (see FIG. 13). Namely, the pressure vessel 13 is supplied with carbon dioxide and the liquid level in the pressure vessel 13 is maintained within a constant range.

The raw water is partially sprinkled or sprayed into the pressure vessel 13 through the first branch pipe 100. The remainder of the raw water is supplied to the lower portion, that is, the liquid-phase region, of the pressure vessel 13 through the second branch pipe 101. The ratio between the rate at which the sodium hypochlorite water solution is supplied through the first branch pipe 100 and that through the second branch pipe 101 can be adjusted using a distribution valve 102, and thus it is possible to adjust the concentration of the carbonated water produced in the pressure vessel 13.

Since the sterile water is produced by taking out the carbonated water produced in the pressure vessel 13 and adjusting the pH value of the sodium hypochlorite water solution with the carbonated water taken out of the pressure vessel 13, it is possible to adjust the pH value of the sterile water by controlling the concentration of the sterile water. That is, the pH value of the sterile water is measured by the pH meter 103 and the distribution valve 102 is controlled for the measured pH value to be a desired target value. As having previously been mentioned, the pH value 103 may be a dissolved carbon-dioxide concentration sensor.

It is generally considered that the sterile water of pH 6.5 to pH 7 is desirable for use in washing meat, for example, and of pH 5 to pH 6 for use in washing vegetable. For such use, the pH value of the sterile water can be controlled by adjusting the concentration of the carbonated water and mixing the carbonated water thus adjusted in concentration with the sodium hypochlorite water solution. Thus, the pH value of the sterile water can easily be controlled correspondingly to an intended use for washing meat or vegetable.

The fifteenth embodiment shown in FIG. 17 may be varied so that the pH value of the carbonated water is controlled by raising or lowering the pressure in the pressure vessel 13. Also in this fifteenth embodiment, the auxiliary pH adjustment may of course be effected using acid such as hydrochloric acid (typically, water-diluted acid) as having previously been described with reference to FIGS. 3 to 5.

In the foregoing, various embodiments of the present invention have been explained. However, the elements included in the embodiments may of course be combined together and the present invention of course includes various variants which would be obvious to those skilled in the art.

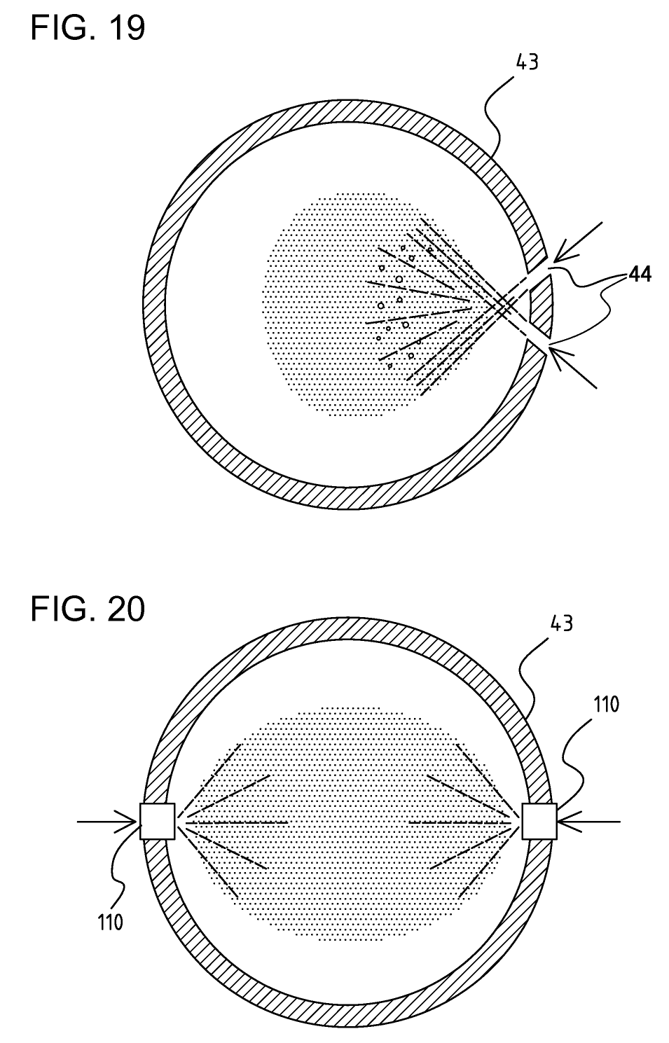

For example, to sprinkle or spray the sodium hypochlorite water solution or raw water into the pressure vessel 13, the small holes 44 may be formed radially and oppositely to each other in the partition 43 as shown in FIG. 18 so that particles of the liquid (sodium hypochlorite water solution or raw water) sprayed from one of the small holes 44 will hit particles of the liquid sprayed from the other small hole 44 for atomization of the liquid. Also, the small holes 44 may be formed adjacently to each other with their axes being laid to intersect each other as shown in FIG. 19 so that the liquid sprayed from one small hole 44 will collide with that sprayed from the other small hole 44. Alternatively, spray nozzles 110 may be provided in lieu of the small holes 44 as shown in FIG. 20. Such small holes 44 or spray nozzles 110 may be formed directly in the side wall of the pressure vessel 13.

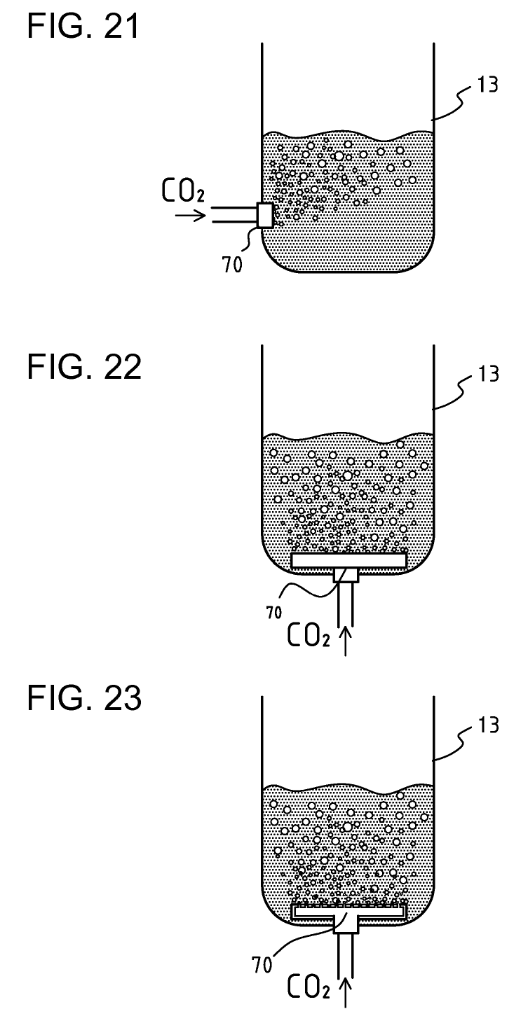

The bubble generator 70 used in the sixth embodiment as shown in FIG. 8 is an example formed from the porous material and nozzle and provided in the lower portion of the pressure vessel 13. FIG. 21 shows an example of the bubble generator 70 whish is formed from a porous sintered member and nozzle, for example, and installed directly to the lower side wall of the pressure vessel 13. FIG. 22 shows another example of the bubble generator 70 which is formed from a porous material. FIG. 23 shows still another example of the bubble generator 70 formed from a box with a plate having many fine holes formed therein. The box is supplied with carbon dioxide to produce micro bubbles.

According to the aforementioned embodiments, sterile water containing hypochlorous or chlorous acid as its major component can be produced from an alkaline hypochlorite or chlorite water solution by a pH adjusting function of carbon dioxide. The pH value of the sterile water is not only stable but can be prevented from entering the strong-acidic range, thereby preventing the production of gaseous chlorine. Also, since the pressure vessel 13 works as an accumulator, so it is not necessary to provide any accumulator or a tank to provisionally store the sterile water separately.

The present invention is most suitably applicable for production of sterile water (weak-acidic) of which the percentage content of hypochlorous or chlorous acid is high. Generally, it is applicable for production of sterile water of about 5 to 8 in pH value.

What is claimed is:

1. A method of producing sterile water containing hypochlorous or chlorous acid as a major component, comprising:
spraying a sodium hypochlorite or chlorite water solution into a pressure vessel filled with carbon dioxide to produce said sterile water.

2. The method according to claim 1, wherein while the sodium hypochlorite or chlorite water solution is sprayed into the pressure vessel, an amount of such sodium hypochlorite or chlorite water solution not sprayed is supplied into the pressure vessel to adjust the pH value of the sterile water under production in the vessel.

3. The method according to claim 2, wherein the ratio between the sodium hypochlorite or chlorite water solution sprayed into the pressure vessel and the sodium hypochlorite or chlorite water solution supplied into the pressure vessel without being sprayed is controlled to control the pH value of the sterile water produced in the pressure vessel.

4. The method according to claim 1, wherein in a preliminary step in which the sodium hypochlorite or chlorite water solution is sprayed into the pressure vessel, an acid other than carbonic acid is added to the sodium hypochlorite or chlorite water solution.

5. The method according to claim 1, wherein an acid other than carbonic acid is added into the pressure vessel.

6. The method according to claim 5, wherein the acid other than carbonic acid is sprayed into the pressure vessel simultaneously when the sodium hypochlorite or chlorite water solution is sprayed into the pressure vessel.

7. The method according to claim 6, wherein the acid other than carbonic acid is brought into collision with particles of the sodium hypochlorite or chlorite water solution sprayed into the pressure vessel.

8. The method according to claim 1, wherein water is added to the sterile water under production in the pressure vessel to adjust the concentration of the sterile water.

9. The method according to claim 1, wherein water is added to the sterile water under production in the vessel to adjust the pH value of the sterile water.

10. The method according to claim 1, wherein a sodium hypochlorite or chlorite water solution is added to the sterile water taken out of the pressure vessel to adjust the pH value of the sterile water.

11. The method according to claim 1, wherein water is added to the sterile water taken out of the pressure vessel to adjust the pH value of the sterile water.

12. The method according to claim 1, wherein carbon dioxide is supplied into a gas-phase region in the pressure vessel.

13. The method according to claim 1, wherein carbon dioxide is supplied into a liquid-phase region in the pressure vessel.

14. The method according to claim 1, wherein the pressure vessel is controlled to keep a constant water level.

15. A method of producing sterile water containing hypochlorous or chlorous acid as a major component, comprising:
spraying water into a pressure vessel filled with carbon dioxide to prepare carbonated water;
supplying water not sprayed into the pressure vessel to adjust the pH value of the carbonated water in the pressure vessel; and
adding the carbonated water adjusted in pH value to a sodium hypochlorite or chlorite water solution to produce said sterile water.

16. A method of producing sterile water containing hypochlorous or chlorous acid as a major component, comprising:
preparing a first pressure vessel and a second pressure vessel;
bringing carbon dioxide and water into contact with each other in the first pressure vessel to produce carbonated water;
bringing carbon dioxide and a sodium hypochlorite or chlorite water solution into contact with each other in the second vessel to produce sterile water; and
adjusting the sterile water in concentration by diluting the sterile water taken out of the second vessel with the carbonated water taken out of the first vessel.

17. A method of producing sterile water containing hypochlorous or chlorous acid as a major component by adding an acid to a sodium hypochlorite or chlorite water solution, comprising:
said acid added to the sodium hypochlorite or chlorite water solution being composed of an acid other than carbonic acid and fresh carbonated water prepared at a location for producing the sterile water by bringing carbon dioxide and water into contact with each other.

18. An apparatus for producing sterile water containing hypochlorous or chlorous acid as a major component, comprising:
a pressure vessel having a mechanism for maintaining a constant range of water level in the pressure vessel;
a means for supplying carbon dioxide to the pressure vessel;
a means for spraying a sodium hypochlorite or chlorite water solution into the pressure vessel; and
a mechanism for maintaining a constant range of pressure in the pressure vessel,
wherein the sodium hypochlorite or chlorite water solution is sprayed in the pressure vessel to bring it into contact with the carbon dioxide and thereby produce said sterile water.

19. The apparatus according to claim 18, further comprising:
a means for supplying the sodium hypochlorite or chlorite water solution in the pressure vessel by other than spraying.
